(19) United States
(12) Patent Application Publication
(10) Pub. No.: US 2022/0150919 A1
(43) Pub. Date: May 12, 2022

(54) TERMINAL AND COMMUNICATION METHOD

(71) Applicant: NTT DOCOMO, INC., Tokyo (JP)

(72) Inventors: Hiroki Harada, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 17/421,276

(22) PCT Filed: Jan. 9, 2019
(86) PCT No.: PCT/JP2019/000414

§ 371 Date: Jul. 7, 2021

(51) Int. Cl. H04W 72/12; H04W 24/08

(52) U.S. Cl. CPC H04W 72/1247; H04W 24/08

(57) ABSTRACT

A terminal comprises: a control unit that, upon receiving a scheduling instruction from a base station, controls which of an RRM measurement operation and a scheduling operation is to be performed in an object resource of an SMTC window or a measurement gap, according to whether or not the scheduling operation priority criteria is satisfied; and a transmitting/receiving unit that, when the scheduling operation is to be preferentially performed, performs downlink reception or uplink transmission in the object resource.

### TECHNICAL FIELD

The present disclosure relates to a terminal and a communication method.

### BACKGROUND ART

Future systems of Long Term Evolution (LTE) in a Universal Mobile Telecommunications System (UMTS) network have been studied (see Non-Patent Literature (hereinafter, referred to as “NPL”) 1). Examples of the future systems of LTE include systems called LTE-Advanced (LTE-A), Future Radio Access (FRA), 5th generation mobile communication system (5G), 5G plus (5G+), New Radio Access Technology (New-RAT; NR), and the like.

When, for example, performing a handover to other cells, or when adding a Component Carrier (CC) in Carrier Aggregation (CA), a terminal measures the reception quality of other cells in advance to appropriately perform the processing while maintaining communication quality.

The measurement of reception quality in NR (Radio Resource Management (RRM)) measurement is performed by using a SS/PBCH Block (SSB) composed of a synchronization signal (SS) having a transmission cycle longer than a Cell specific Reference Signal (CRS) and a downlink physical broadcast channel (PBCH).

The RRM measurement cycle does not have to be the same as the SSB transmission cycle, and is preferably configured appropriately according to the environment in order to reduce the power consumption of the terminal. The SSB based RRM measurement Timing Configuration (SMTC) window, which is a function to notify the terminal of the measurement cycle and timing of the SSB used by the terminal from its own cell, has been introduced.

In addition, the terminal needs to suspend the current communication in order to measure the reception quality of the cell/CC having a frequency different from that of the own cell. This suspension period is referred to as a measurement gap (see Non-Patent Literature (hereinafter, referred to as “NPL”) 1).

The cycle of the SMTC window and the cycle of the measurement gap are notified from the base station to the terminal by the RRC configuration.

Except for special cases, the terminal prioritizes an RRM measurement operation over a scheduling operation in the resource targeted for the SMTC window or the measurement gap (hereinafter simply referred to as “target resource”), and does not receive the DL signal and transmit the UL signal (scheduling restriction) (see NPL 2).

### CITATION LIST

### Non-Patent Literature

### NPL 1

3GPP TS 38.133 V15.4.0

### NPL 2

3GPP TS 38.213 V15.4.0

### SUMMARY OF INVENTION

### Technical Problem

Future radio systems require dynamic and flexible resource utilization.

However, as described above, except for a special case, the RRM measurement operation has been always prioritized over the scheduling operation (DL signal reception and UL signal transmission), so that resources cannot be utilized dynamically and flexibly.

One object of the present disclosure is to utilize resources dynamically and flexibly.

### Solution to Problem

A terminal according to one aspect of the present disclosure includes: a control section that controls, when a scheduling instruction is received from a base station, which of an RRM measurement operation and a scheduling operation is to be executed with priority in a target resource of one of a SMTC window and a measurement gap according to whether or not a criterion of prioritizing the scheduling operation is satisfied; and a transmission and reception section that performs downlink reception or uplink transmission in the target resource when the scheduling operation is to be prioritized.

### Advantageous Effects of Invention

According to the present disclosure, even when a scheduling restriction has been occurred in conventional cases, the RRM measurement operation can be canceled and the scheduling operation can be performed, so that resources can be utilized dynamically and flexibly.

### BRIEF DESCRIPTION OF DRAWINGS

FIG. 1 is a block diagram illustrating an exemplary configuration of a base station;

FIG. 2 is a block diagram illustrating an exemplary configuration of a terminal;

FIG. 3 illustrates an exemplary priority control of prioritizing a scheduling operation according to one embodiment of the present disclosure;

FIG. 4 illustrates an exemplary priority control of prioritizing a scheduling operation according to one embodiment of the present disclosure; and

FIG. 5 illustrates an exemplary hardware configuration of the base station and the terminal.

### DESCRIPTION OF EMBODIMENTS

Hereinafter, an embodiment of the present disclosure will be described with reference to the accompanying drawings.

### Embodiment 1

NPL 2 specifies that in a Frequency Range 1 (FR1, 450 MHz-6.0 GHz) TDD band, when there is no scheduling restriction by RRM measurement, and when the terminal is scheduled for UL transmission, RRM measurement using SSB of neighboring cells or Channel State Information-Reference Signal (CSI-RS) does not have to be performed on the symbol, and specifies that in the FR1 TDD band, when Subcarrier Spacing (SC S) of data is different from SSB and a terminal does not support the capability of simultaneousRxDataSSB-DiffNumerology, scheduling restriction by RRM measurement occurs.

NPL 1 describes that in FR1, when SSB and the SCS of PDCCH/PDSCH are different, and the terminal does not support the capability of simultaneousRxDataSSB-DiffNumerology (not reporting to the base station), the terminal prioritizes the RRM measurement over a scheduling operation, and the reception of Physical Downlink Control Channel (PDCCH)/Physical Downlink Shared Channel (PDSCH)/Tracking Reference Signal (TRS)/CSI-RS or the transmission of Physical Uplink Control Channel (PUCCH)/Physical Uplink Shared Channel (PUSCH)/Sounding Reference Signal (SRS) may not be performed during that period, and also describes that when a scheduling restriction occurs in a given CC during intra-band CA, the same scheduling restriction also occurs in other intra-band CCs.

NPL 1 also describes that in Frequency Range 2 (FR2, 24.25 GHz-52.6 GHz), the terminal prioritizes RRM measurement over a scheduling operation regardless of SCS due to the limitation of analog beamforming, and the reception of the PDCCH/PDSCH/TRS/CSI-RS or the transmission of the PUCCH/PUSCH/SRS may not be performed during that period, and describes that when a scheduling restriction occurs in a given CC during FR2 intra/inter-band CA, the same scheduling restriction also occurs in other FR2 intra/inter-band CCs.

As described above, in the FR1 TDD band of a conventional case, except in the special case such that the SSB and the SCS of the data are the same, or the terminal always supports the capability of simultaneousRxDataSSB-DiffNumerology, the RRM measurement operation is prioritized over the scheduling operation and scheduling restriction occurs in the target resource.

For this reason, resources for performing RRM measurement of neighboring cells cannot be utilized in conventional cases for UL data transmission and DL data reception in Dynamic TDD.

Further, in URLLC, resources for performing RRM measurement of neighboring cells cannot be utilized, although it is necessary to transmit UL data and receive DL data with low delay in conventional cases.

The present disclosure has been made to solve the above problem. Hereinafter, one aspect of the present disclosure will be described with reference to the accompanying drawings.

[Configuration of Radio Communication System]

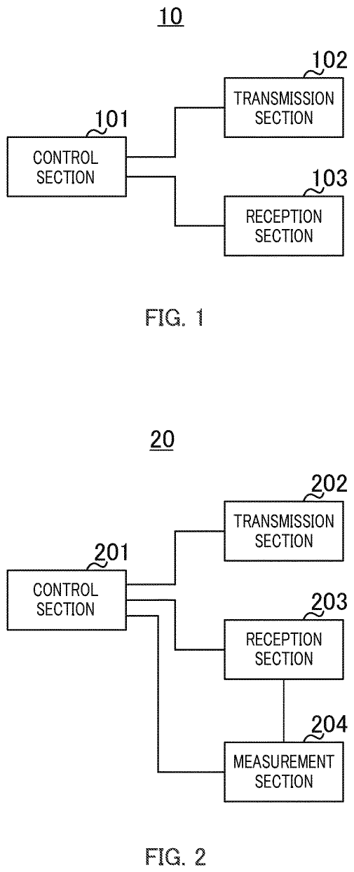

A radio communication system according to the present embodiment includes base station 10 (see FIG. 1) and terminal 20 (see FIG. 2). Base station 10 transmits a DL signal to terminal 20. In addition, base station 10 receives a UL signal transmitted from terminal 20. Terminal 20 receives the DL signal transmitted from base station 10, and transmits the UL signal to base station 10.

[Configuration of Base Station 10]

FIG. 1 is a block diagram illustrating an exemplary configuration of base station 10 according to the present embodiment. Base station 10 includes control section 101, transmission section 102, and reception section 103, for example.

Control section 101 controls transmission processing of transmission section 102 and reception processing of reception section 103.

For example, control section 101 performs scheduling (e.g., resource allocation) for a DL data signal to be transmitted on PDSCH and for a DL control signal to be transmitted on a PDCCH. Control section 101 performs scheduling also for a DL reference signal such as a synchronization signal (Primary Synchronization Signal (PSS)/Secondary Synchronization Signal (SSS)), CRS, CSI-RS, or the like.

Control section 101 performs scheduling also for a UL data signal to be transmitted on a PUSCH, a UL control signal to be transmitted on a PUCCH, a random access preamble to be transmitted on a PRACH, a UL reference signal, and the like.

In addition, control section 101 performs connected-cell selection for terminal 20 or the like based on RRM report that is included in the UL signal and indicates a measurement result of the reception quality.

Transmission section 102 transmits a signal (DL signal) for terminal 20 to terminal 20 under the control of control section 101.

Examples of the DL signal include DL data (also referred to as a PDSCH signal, for example), DL control information (also referred to as a PDCCH signal; the PDCCH includes Downlink Control Information (DCI), for example) and a reference signal. Examples of the DL control information include: a RA message (also referred to as Random Access Response (RAR) or message 2, for example) including a Timing Advance (TA) command; and information indicating a UL resource configuration (scheduling indication).

Terminal 20 may be notified of the DL control information through higher layer signaling, or through dynamic signaling of DCI or the like, for example. The higher layer signaling may also be referred to as Radio Resource Control (RRC) signaling or a higher layer parameter, for example.

Reception section 103 receives a signal (UL signal) transmitted from terminal 20 under the control of control section 101.

Examples of the UL signal include UL data (also referred to as a PUSCH signal, for example), UL control information (also referred to as a PUCCH signal, for example), a reference signal (SRS, for example) and a RA signal. Examples of the UL signal may include an RRM report.

[Configuration of Terminal 20]

FIG. 2 is a block diagram illustrating an exemplary configuration of terminal 20 according to the present embodiment. Terminal 20 includes, for example, control section 201, transmission section 202, reception section 203, and measurement section 204.

Control section 201 controls transmission processing of transmission section 202 and reception processing of reception section 203, for example.

When a scheduling instruction is received from base station 10, for example, control section 201 controls which of an RRM measurement operation and a scheduling operation is to be executed with priority in a target resource according to whether or not a criterion of prioritizing the scheduling operation is satisfied (hereinafter, referred to as “priority control”).

Transmission section 202 transmits a UL signal to base station 10 under the control of control section 201. For example, when transmission section 202 receives a UL scheduling instruction from control section 201, transmission section 202 receives the UL signal also in the target resource.

Reception section 203 receives a DL signal transmitted from terminal 10 under the control of control section 201. For example, when reception section 203 receives a DL scheduling instruction from control section 201, reception section 203 receives the DL signal also in the target resource.

When measurement section 204 receives an RRM measurement instruction from control section 201, measurement section 204 measures the reception quality of the signal received by reception section 203 in the target resource. Examples of the value indicating the reception quality include the reception power of the received signal (for example, Reference Signal Received Power (RSRP)), reception signal strength (for example, Received Signal Strength Indicator (RSSI)), and reception quality (for example, Reference Signal Received Quality (RSRQ)). The RRM report may be transmitted from transmission section 202 to base station 10.

[Priority Control]

In the following, an example of priority control in terminal 20 (control section 201) will be described.

### Example 1

In Example 1, the fact that terminal 20 supports the UE capability of prioritizing a scheduling operation is used as the criterion of prioritizing the scheduling operation.

In this example, when terminal 20, which supports the UE capability of prioritizing a scheduling operation, receives a scheduling (DL scheduling or UL scheduling) instruction from base station 10, terminal 20 cancels the RRM measurement operation in the target resource and performs the scheduling operation, that is, executes the scheduling operation with priority (i.e., preferentially execute the scheduling operation). On the other hand, terminal 20, which does not support the UE capability of prioritizing a scheduling operation, performs the RRM measurement operation in the target resource even when terminal 20 receives the scheduling instruction from base station 10.

Herein, the UE capability of prioritizing a scheduling operation is a function capable of dynamically canceling the RRM measurement operation.

The UE capability of prioritizing a scheduling operation may be configured by this function alone, or may be linked to other functions related to Dynamic TDD or URLLC.

### Example 2

In Example 2, the fact that terminal 20 receives an instruction of prioritizing a scheduling operation from base station 10 is used as the criterion of prioritizing the scheduling operation.

In this example, when terminal 20, which receives the instruction of prioritizing a scheduling operation from base station 10, receives a scheduling instruction from base station 10, terminal 20 cancels the RRM measurement operation in the target resource and performs the scheduling operation. On the other hand, terminal 20, which does not receive the instruction of prioritizing a scheduling operation from base station 10, performs the RRM measurement operation in the target resource even when terminal 20 receives the scheduling instruction from base station 10.

The instruction of prioritizing a scheduling operation from base station 10 may be notified to terminal 20 by RRC signaling, MAC Control Element (MAC CE) or DCI.

### Example 3

In Example 3, the fact that terminal 20 supports the UE capability of prioritizing a scheduling operation and also receives an instruction of prioritizing the scheduling operation from base station 10 is used as the criterion of prioritizing the scheduling operation.

In this example, when terminal 20, which supports the UE capability of prioritizing a scheduling operation and also receives the instruction of prioritizing the scheduling operation from base station 10, receives a scheduling instruction, terminal 20 cancels the RRM measurement operation in the target resource and performs the scheduling operation. On the other hand, terminal 20, which does not support the UE capability of prioritizing a scheduling operation or receive an instruction of prioritizing a scheduling operation from base station 10, performs the RRM measurement operation in the target resource even when terminal 20 receives the scheduling instruction from base station 10.

In each of the above examples, terminal 20 that satisfies the criterion of prioritizing the scheduling operation may be semi-statically or dynamically switchable between to prioritize the RRM measurement operation and to prioritize the scheduling operation. In the case of semi-static switching, specifically, terminal 20 may prioritize the scheduling operation until a predetermined period passes after receiving a notification from base station 10, and may prioritize the RRM measurement operation after the predetermined period passes or when the notification from the base station 10 is not received after a predetermined condition is satisfied. Examples of the predetermined condition include a case where a predetermined time passes since the RRM measurement operation was canceled and the scheduling operation was last performed, or a case where a condition for the event trigger report was satisfied in the reception quality measurement result. Further, in the case of dynamic switching, specifically, terminal 20 prioritize the scheduling operation after receiving a notification of prioritizing the scheduling operation from the base station 10 until receiving a notification of prioritizing the RRM measurement operation from the base station 10, for example.

When the scheduling instruction is not received from base station 10, terminal 20 performs the RRM measurement operation in the target resource even when terminal 20 satisfies the criterion of prioritizing the scheduling operation.

### Effects

As described above, a scheduling operation can be performed by dynamically canceling an RRM measurement operation in the present embodiment even when the scheduling restriction has occurred in conventional cases. According to the present embodiment, resources thus can be utilized dynamically and flexibly, and it is possible to deal with low-delay applications and the like.

In the present embodiment, although the part that can be changed in Rel-16 and later is only the operation of some terminals as the specifications of Rel-15 are already fixed, it is possible to dynamically cancel the RRM measurement operation for some terminals recognized by the base station, and thus easy implementation is possible in Rel-16 and later.

Dynamic cancellation of an RRM measurement operation may cause effects such as a delayed measurement result or reduction of the accuracy of the measurement result, but the effects will not cause a big problem as a system when the cancellation of the RRM measurement operation is short-term.

[Variations]

Variations of the priority control according to the present embodiment will be described in the following.

<Variation 1>

In DL scheduling, the fact that the time interval from the reception of scheduling DCI to a target resource is a predetermined threshold or more may be used as an additional condition during the cancellation of the RRM measurement operation in the present embodiment.

For example, terminal 20 may cancel the RRM measurement operation by the DL scheduling when the above-described criterion of prioritizing a scheduling operation is satisfied and the time interval from the reception of the scheduling DCI to the target resource is a predetermined threshold or more. On the other hand, when the DL scheduling collides with the target resource, that is, when the DL scheduling is performed at a time interval from the reception of the scheduling DCI to the target resource less than the predetermined threshold, terminal 20 may prioritize the RRM measurement operation even when the above-described criterion of prioritizing the scheduling operation is satisfied.

The above described predetermined threshold may be defined by the specifications, or may be notified from base station 10 to terminal 20 as information regarding the minimum time interval that can be supported by the UE capability.

<Variation 2>

The terminal 20 may control whether or not to cancel the RRM measurement operation by a scheduling instruction according to the target of the RRM measurement operation in the present embodiment.

For example, terminal 20 may perform controlling not to cancel the RRM measurement operation for the SSB of a serving cell, but cancel the RRM measurement operation for the CSI-RS of the serving cell and the SSB/CSI-RS of neighboring cells.

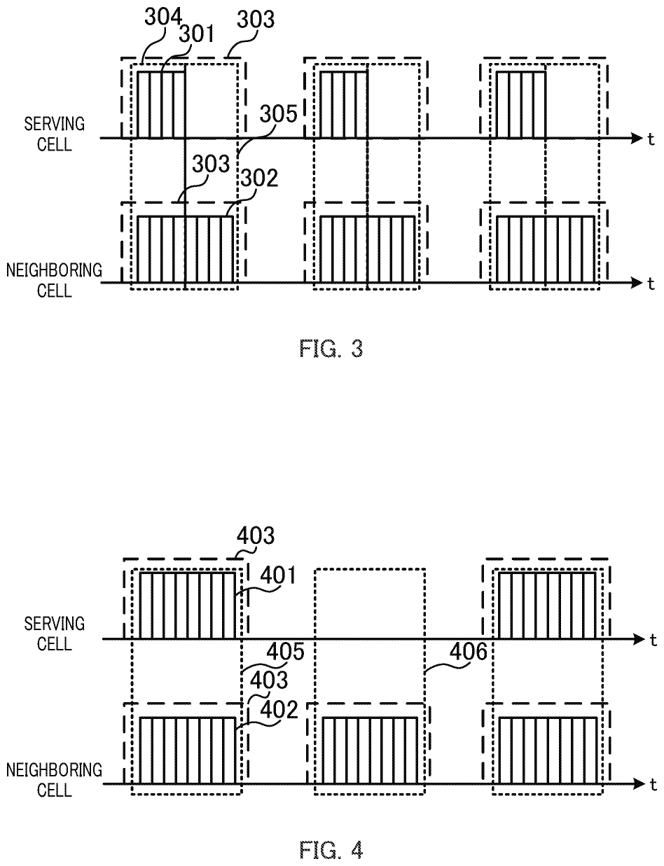

As illustrated in FIG. 3, when SSB 301 of the serving cell and SSB 302 of the neighboring cell have the same transmission cycle and transmission start timing, and SSB 301 is shorter than SSB 302, the width of SMTC window 303 is configured according to the length of SSB 302. In this case, in variation 2, terminal 20 performs the RRM measurement operation in section 304 that receives SSB 301, cancels the RRM measurement operation and performs the scheduling operation in section 305 that does not receive SSB 301 and receives only SSB 302.

As illustrated in FIG. 4, when the transmission cycle of SSB 401 of the serving cell is longer than the transmission cycle of SSB 402 of the neighboring cell, terminal 20 performs the RRM measurement operation in section 405 which configures SMTC window 403 for SSB 401, and terminal 20 cancels the RRM measurement operation and performs the scheduling operation in section 406 which does not receive SSB 401 and configures only SMTC window 404 for SSB 402.

<Variation 3>

In the present embodiment, whether or not to cancel the RRM measurement operation by the scheduling instruction, or the cancellation method may be different depending on outside or inside the measurement gap.

For example, in the case outside the measurement gap, the condition for canceling the RRM measurement operation is that the above described criterion of prioritizing the scheduling operation is satisfied. On the other hand, in the case inside the measurement gap (during different frequency measurement), the condition for canceling the RRM measurement operation are, in addition to satisfying the above described criterion of prioritizing the scheduling operation, that scheduling DCI is received before opening of the measurement gap, that there is time corresponding to RF retuning time or more between the scheduling DCI and the target resource, and the like. Alternatively, the RRM measurement operation may always be prioritized in the case inside the measurement gap, and the RRM measurement operation may be canceled and the scheduling operation may be performed in the case outside the measurement gap.

<Variation 4>

In the present embodiment, terminal 20 may cancel the RRM measurement operation in a predetermined CC based on a scheduling instruction in another CC during the CA.

In Inter-band CA using CCs of different bands, whether or not the RRM measurement operation in another band is canceled by scheduling to CC in a predetermined band may be fixed by the specification regardless of the band-combination, or may change depending on the band-combination (UE capability).

The embodiments of the present disclosure have been described above.

(Hardware Configuration)

Note that, the block diagrams used to describe the above embodiment illustrate blocks on the basis of functions. These functional blocks (component sections) are implemented by any combination of at least hardware or software. A method for implementing the functional blocks is not particularly limited. That is, the functional blocks may be implemented using one physically or logically coupled apparatus. Two or more physically or logically separate apparatuses may be directly or indirectly connected (for example, via wires or by radio), and the plurality of apparatuses may be used to implement the functional blocks. The functional blocks may be implemented by combining software with the one apparatus or the plurality of apparatuses described above.

The functions include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component section) that functions to achieve transmission is referred to as “transmission section,” “transmitting unit,” or “transmitter.” The methods for implementing the functions are not particularly limited as described above.

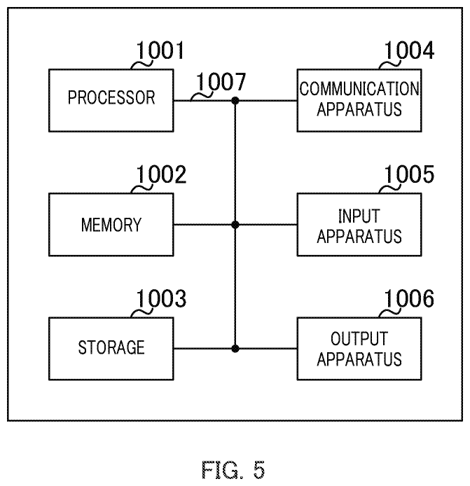

For example, the base station, user terminal, and the like according to an embodiment of the present disclosure may function as a computer that executes processing of a radio communication method of the present disclosure. FIG. 5 illustrates an exemplary hardware configuration of base station 10 and terminal 20 according to one embodiment of the present disclosure. Physically, base station 10 and terminal 20 as described above may be configured as a computer apparatus including processor 1001, memory 1002, storage 1003, communication apparatus 1004, input apparatus 1005, output apparatus 1006, bus 1007, and the like.

Note that the term “apparatus” in the following description can be replaced with a circuit, a device, a unit, or the like. The hardware configurations of base station 10 and of terminal 20 may include one apparatus or a plurality of apparatuses illustrated in the drawings or may not include part of the apparatuses.

The functions of base station 10 and terminal 20 are implemented by predetermined software (program) loaded into hardware, such as processor 1001, memory 1002, and the like, according to which processor 1001 performs the arithmetic and controls communication performed by communication apparatus 1004 or at least one of reading and writing of data in memory 1002 and storage 1003.

Processor 1001 operates an operating system to control the entire computer, for example. Processor 1001 may be composed of a central processing unit (CPU) including an interface with peripheral apparatuses, control apparatus, arithmetic apparatus, register, and the like. For example, control sections 101 and 201 and the like as described above may be implemented using processor 1001.

Processor 1001 reads a program (program code), a software module, data, and the like from at least one of storage 1003 and communication apparatus 1004 to memory 1002 and performs various types of processing according to the program (program code), the software module, the data, and the like. As the program, a program for causing the computer to perform at least a part of the operation described in the above embodiments is used. For example, control sections 101 and 201 of base station 10 and terminal 20 may be implemented using a control program stored in memory 1002 and operated by processor 1001, and the other functional blocks may also be implemented in the same way. While it has been described that the various types of processing as described above are performed by one processor 1001, the various types of processing may be performed by two or more processors 1001 at the same time or in succession. Processor 1001 may be implemented using one or more chips. Note that the program may be transmitted from a network through a telecommunication line.

Memory 1002 is a computer-readable recording medium and may be composed of, for example, at least one of a Read Only Memory (ROM), an Erasable Programmable ROM (EPROM), an Electrically Erasable Programmable ROM (EEPROM), and a Random Access Memory (RAM). Memory 1002 may be called as a register, a cache, a main memory (main storage apparatus), or the like. Memory 1002 can save a program (program code), a software module, and the like that can be executed to perform the radio communication method according to an embodiment of the present disclosure.

Storage 1003 is a computer-readable recording medium and may be composed of, for example, at least one of an optical disk such as a Compact Disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. Storage 1003 may also be called as an auxiliary storage apparatus. The storage medium as described above may be, for example, a database, a server, or other appropriate media including at least one of memory 1002 and storage 1003.

Communication apparatus 1004 is hardware (transmission and reception device) for communication between computers through at least one of wired and radio networks and is also called as, for example, a network device, a network controller, a network card, or a communication module. Communication apparatus 1004 may be configured to include a high frequency switch, a duplexer, a filter, a frequency synthesizer, and the like in order to achieve at least one of Frequency Division Duplex (FDD) and Time Division Duplex (TDD), for example. For example, transmission sections 102 and 202, reception sections 103 and 203, measurement section 204, and the like as described above may be implemented using communication apparatus 1004.

Input apparatus 1005 is an input device (for example, a keyboard, a mouse, a microphone, a switch, a button, or a sensor) that receives input from the outside. Output apparatus 1006 is an output device (for example, a display, a speaker, or an LED lamp) which makes outputs to the outside. Note that input apparatus 1005 and output apparatus 1006 may be integrated (for example, a touch panel).

The apparatuses, such as processor 1001, memory 1002, and the like are connected by bus 1007 for communication of information. Bus 1007 may be configured using a single bus or using buses different between each pair of the apparatuses.

Furthermore, base station 10 and terminal 20 may include hardware, such as a microprocessor, a digital signal processor (DSP), an Application Specific Integrated Circuit (ASIC), a Programmable Logic Device (PLD), and a Field Programmable Gate Array (FPGA), and the hardware may implement part or all of the functional blocks. For example, processor 1001 may be implemented using at least one of these pieces of hardware.

(Notification of Information and Signaling)

The notification of information is not limited to the aspects or embodiments described in the present disclosure, and the information may be notified by another method. For example, the notification of information may be performed out by one or a combination of physical layer signaling (for example, Downlink Control Information (DCI) and Uplink Control Information (UCI)), upper layer signaling (for example, Radio Resource Control (RRC) signaling, Medium Access Control (MAC) signaling, notification information (Master Information Block (MIB), and System Information Block (SIB))), and other signals. The RRC signaling may be called an RRC message and may be, for example, an RRC connection setup message, an RRC connection reconfiguration message, or the like.

(Adaptive System)

The aspects and embodiments described in the present specification may be applied to at least one of systems using Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or other appropriate systems and a next-generation system extended based on the above systems. Additionally or alternatively, a combination of two or more of the systems (e.g., a combination of at least LTE or LTE-A and 5G) may be applied.

(Processing Procedure and the Like)

The orders of the processing procedures, the sequences, the flow charts, and the like of the aspects and embodiments described in the present disclosure may be changed as long as there is no contradiction. For example, elements of various steps are presented in exemplary orders in the methods described in the present disclosure, and the methods are not limited to the presented specific orders.

(Operation of Base Station)

Specific operations which are described in the present disclosure as being performed by the base station may sometimes be performed by an upper node depending on the situation. Various operations performed for communication with a user equipment in a network constituted by one network node or a plurality of network nodes including a base station can be obviously performed by at least one of the base station and a network node other than the base station (examples include, but not limited to, MME or S-GW). Although there is one network node in addition to the base station in the case illustrated above, a plurality of other network nodes may be combined (for example, MME and S-GW).

(Direction of Input and Output)

The information, the signals, and the like can be output from a higher layer (or a lower layer) to a lower layer (or a higher layer). The information, the signals, and the like may be input and output through a plurality of network nodes.

(Handling of Input and Output Information and the Like)

The input and output information and the like may be saved in a specific place (for example, memory) or may be managed using a management table. The input and output information and the like can be overwritten, updated, or additionally written. The output information and the like may be deleted. The input information and the like may be transmitted to another apparatus.

(Determination Method)

The determination may be made based on a value expressed by one bit (0 or 1), based on a Boolean value (true or false), or based on comparison with a numerical value (for example, comparison with a predetermined value).

(Software)

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information, and the like may be transmitted and received through a transmission medium. For example, when the software is transmitted from a website, a server, or another remote source by using at least one of a wired technique (e.g., a coaxial cable, an optical fiber cable, a twisted pair, and a digital subscriber line (DSL)) and a radio technique (e.g., an infrared ray and a microwave), the at least one of the wired technique and the radio technique is included in the definition of the transmission medium.

(Information and Signals)

The information, the signals, and the like described in the present disclosure may be expressed by using any of various different techniques. For example, data, instructions, commands, information, signals, bits, symbols, chips, and the like that may be mentioned throughout the entire description may be expressed by one or an arbitrary combination of voltage, current, electromagnetic waves, magnetic fields, magnetic particles, optical fields, and photons.

Note that the terms described in the present disclosure and the terms necessary to understand the present disclosure may be replaced with terms with the same or similar meaning. For example, at least one of the channel and the symbol may be a signal (signaling). The signal may be a message. The component carrier (CC) may be called a carrier frequency, a cell, a frequency carrier, or the like.

(“System” and “Network”)

The terms “system” and “network” used in the present disclosure can be interchangeably used.

(Names of Parameters and Channels)

The information, the parameters, and the like described in the present disclosure may be expressed using absolute values, using values relative to predetermined values, or using other corresponding information. For example, radio resources may be indicated by indices.

The names used for the parameters are not limitative in any respect. Furthermore, the numerical formulas and the like using the parameters may be different from the ones explicitly disclosed in the present disclosure. Various channels (for example, PUCCH and PDCCH) and information elements, can be identified by any suitable names, and various names assigned to these various channels and information elements are not limitative in any respect.

(Base Station)

The terms “Base Station (BS),” “radio base station,” “fixed station,” “NodeB,” “eNodeB (eNB),” “gNodeB (gNB),” “access point,” “transmission point,” “reception point, “transmission/reception point,” “cell,” “sector,” “cell group,” “carrier,” and “component carrier” may be used interchangeably in the present disclosure. The base station may be called a macro cell, a small cell, a femtocell, or a pico cell.

The base station can accommodate one cell or a plurality of (for example, three) cells. When the base station accommodates a plurality of cells, the entire coverage area of the base station can be divided into a plurality of smaller areas, and each of the smaller areas can provide a communication service based on a base station subsystem (for example, small base station for indoor remote radio head (RRH)). The term “cell” or “sector” denotes part or all of the coverage area of at least one of the base station and the base station subsystem that perform the communication service in the coverage.

(Terminal)

The terms “Mobile Station (MS),” “user terminal,” “User Equipment (UE),” and “terminal” may be used interchangeably in the present disclosure.

The mobile station may be called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or by some other appropriate terms.

(Base Station/Mobile Station)

At least one of the base station and the mobile station may be called a transmission apparatus, a reception apparatus, a communication apparatus, or the like. Note that, at least one of the base station and the mobile station may be a device mounted in a mobile entity, the mobile entity itself, or the like. The mobile entity may be a vehicle (e.g., an automobile or an airplane), an unmanned mobile entity (e.g., a drone or an autonomous vehicle), or a robot (a manned-type or unmanned-type robot). Note that, at least one of the base station and the mobile station also includes an apparatus that does not necessarily move during communication operation. For example, at least one of the base station and the mobile station may be Internet-of-Things (IoT) equipment such as a sensor.

The base station in the present disclosure may also be replaced with the user equipment. For example, the aspects and the embodiments of the present disclosure may find application in a configuration that results from replacing communication between the base station and the user equipment with communication between multiple user equipments (such communication may, e.g., be referred to as device-to-device (D2D), vehicle-to-everything (V2X), or the like). In this case, user equipment 20 may be configured to have the functions that base station 10 described above has. The wordings “uplink” and “downlink” may be replaced with a corresponding wording for inter-equipment communication (for example, “side”). For example, an uplink channel, a downlink channel, and the like may be replaced with a side channel.

Similarly, the user equipment in the present disclosure may be replaced with the base station. In this case, base station 10 is configured to have the functions that user equipment 20 described above has.

### Meaning and Interpretation of Terms

As used herein, the term “determining” may encompass a wide variety of actions. For example, “determining” may be regarded as judging, calculating, computing, processing, deriving, investigating, looking up, searching (or, search or inquiry) (e.g., looking up in a table, a database or another data structure), ascertaining and the like. Furthermore, “determining” may be regarded as receiving (for example, receiving information), transmitting (for example, transmitting information), inputting, outputting, accessing (for example, accessing data in a memory) and the like. Also, “determining” may be regarded as resolving, selecting, choosing, establishing, comparing and the like. That is, “determining” may be regarded as a certain type of action related to determining. Also, “determining” may be replaced with “assuming,” “expecting,” “considering,” and the like.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like that are non-limiting and non-inclusive examples.

The reference signal can also be abbreviated as an RS and may also be called as a pilot depending on the applied standard.

The description “based on” used in the present disclosure does not mean “based only on,” unless otherwise specified. In other words, the description “based on” means both of “based only on” and “based at least on.”

Any reference to elements by using the terms “first,” “second,” and the like that are used in the present disclosure does not generally limit the quantities of or the order of these elements. The terms can be used as a convenient method of distinguishing between two or more elements in the present disclosure. Therefore, reference to first and second elements does not mean that only two elements can be employed, or that the first element has to precede the second element somehow.

The “section” in the configuration of each apparatus may be replaced with “means,” “circuit,” “device,” or the like.

In a case where terms “include,” “including,” and their modifications are used in the present disclosure, these terms are intended to be inclusive like the term “comprising.” Further, the term “or” used in the present disclosure is not intended to be an exclusive or.

The radio frame may be constituted by one frame or a plurality of frames in the time domain.

The one frame or each of the plurality of frames may be called a subframe in the time domain. The subframe may be further constituted by one slot or a plurality of slots in the time domain. The subframe may have a fixed time length (e.g., 1 ms) independent of numerology.

The numerology may be a communication parameter that is applied to at least one of transmission and reception of a certain signal or channel. The numerology, for example, indicates at least one of SubCarrier Spacing (SCS), a bandwidth, a symbol length, a cyclic prefix length, Transmission Time Interval (TTI), the number of symbols per TTI, a radio frame configuration, specific filtering processing that is performed by a transmission and reception apparatus in the frequency domain, specific windowing processing that is performed by the transmission and reception apparatus in the time domain, and the like.

The slot may be constituted by one symbol or a plurality of symbols (e.g., Orthogonal Frequency Division Multiplexing (OFDM)) symbol, Single Carrier-Frequency Division Multiple Access (SC-FDMA) symbol, or the like) in the time domain. The slot may also be a time unit based on the numerology.

The slot may include a plurality of mini-slots. Each of the mini-slots may be constituted by one or more symbols in the time domain. Furthermore, the mini-slot may be referred to as a subslot. The mini-slot may be constituted by a smaller number of symbols than the slot. A PDSCH (or a PUSCH) that is transmitted in the time unit that is greater than the mini-slot may be referred to as a PDSCH (or a PUSCH) mapping type A. The PDSCH (or the PUSCH) that is transmitted using the mini-slot may be referred to as a PDSCH (or PUSCH) mapping type B.

The radio frame, the subframe, the slot, the mini slot, and the symbol indicate time units in transmitting signals. The radio frame, the subframe, the slot, the mini slot, and the symbol may be called by other corresponding names.

For example, one subframe, a plurality of continuous subframes, one slot, or one mini-slot may be called a Transmission Time Interval (TTI). That is, at least one of the subframe and the TTI may be a subframe (1 ms) in the existing LTE, a duration (for example, 1 to 13 symbols) that is shorter than 1 ms, or a duration that is longer than 1 ms. Note that, a unit that represents the TTI may be referred to as a slot, a mini-slot, or the like instead of a subframe.

Here, the TTI, for example, refers to a minimum time unit for scheduling in radio communication. For example, in an LTE system, the base station performs scheduling for allocating a radio resource (a frequency bandwidth, a transmit power, and the like that are used in each user terminal) on the basis of TTI to each user terminal. Note that, the definition of TTI is not limited to this.

The TTI may be a time unit for transmitting a channel-coded data packet (a transport block), a code block, or a codeword, or may be a unit for processing such as scheduling and link adaptation. Note that, when the TTI is assigned, a time section (for example, the number of symbols) to which the transport block, the code block, the codeword, or the like is actually mapped may be shorter than the TTI.

Note that, in a case where one slot or one mini-slot is referred to as the TTI, one or more TTIs (that is, one or more slots, or one or more mini-slots) may be a minimum time unit for the scheduling. Furthermore, the number of slots (the number of mini-slots) that make up the minimum time unit for the scheduling may be controlled.

A TTI that has a time length of 1 ms may be referred to as a usual TTI (a TTI in LTE Rel. 8 to LTE Rel. 12), a normal TTI, a long TTI, a usual subframe, a normal subframe, a long subframe, a slot, or the like. A TTI that is shorter than the usual TTI may be referred to as a shortened TTI, a short TTI, a partial TTI (or a fractional TTI), a shortened subframe, a short subframe, a mini-slot, a subslot, a slot, or the like.

Note that the long TTI (for example, the usual TTI, the subframe, or the like) may be replaced with the TTI that has a time length which exceeds 1 ms, and the short TTI (for example, the shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be identical regardless of the numerology, and may be 12, for example. The number of subcarriers that are included in the RB may be determined based on the numerology.

In addition, the RB may include one symbol or a plurality of symbols in the time domain, and may have a length of one slot, one mini slot, one subframe, or one TTI. One TTI and one subframe may be constituted by one resource block or a plurality of resource blocks.

Note that one or more RBs may be referred to as a Physical Resource Block (PRB), a Sub-Carrier Group (SCG), a Resource Element Group (REG), a PRB pair, an RB pair, or the like.

In addition, the resource block may be constituted by one or more Resource Elements (REs). For example, one RE may be a radio resource region that is one subcarrier and one symbol.

A bandwidth part (BWP) (which may be referred to as a partial bandwidth or the like) may represent a subset of contiguous common resource blocks (RB) for certain numerology in a certain carrier. Here, the common RBs may be identified by RB indices that use a common reference point of the carrier as a reference. The PRB may be defined by a certain BWP and may be numbered within the BWP.

The BWP may include a UL BWP and a DL BWP. An UE may be configured with one or more BWPs within one carrier.

At least one of the configured BWPs may be active, and the UE does not have to assume transmission/reception of a predetermined signal or channel outside the active BWP. Note that, “cell,” “carrier,” and the like in the present disclosure may be replaced with “BWP.”

Structures of the radio frame, the subframe, the slot, the mini-slot, the symbol, and the like are described merely as examples. For example, the configuration such as the number of subframes that are included in the radio frame, the number of slots per subframe or radio frame, the number of mini-slots that are included within the slot, the numbers of symbols and RBs that are included in the slot or the mini-slot, the number of subcarriers that are included in the RB, the number of symbols within the TTI, the symbol length, the Cyclic Prefix (CP) length, and the like can be changed in various ways.

In a case where articles, such as “a,” “an,” and “the” in English, for example, are added in the present disclosure by translation, nouns following these articles may have the same meaning as used in the plural.

(Variations and the Like of Aspects)

The aspects and embodiments described in the present disclosure may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiments described in the present disclosure. Modifications and variations of the aspects of the present disclosure can be made without departing from the spirit and the scope of the present disclosure defined by the description of the appended claims. Therefore, the description of the present disclosure is intended for exemplary description and does not limit the present disclosure in any sense.

### INDUSTRIAL APPLICABILITY

One aspect of the present disclosure is useful for radio communication systems.

### REFERENCE SIGNS LIST

10 Base station
20 Terminal
101, 201 Control section
102, 202 Transmission section
103, 203 Reception section
204 Measurement section

1. A terminal, comprising:
a control section that controls, when a scheduling instruction is received from a base station, which of an RRM measurement operation and a scheduling operation is to be executed with priority in a target resource of a SMTC window or a measurement gap, according to whether or not a criterion of prioritizing the scheduling operation is satisfied; and
a transmission and reception section that performs downlink reception or uplink transmission in the target resource when the scheduling operation is to be prioritized.

2. The terminal according to claim 1, wherein:
when the terminal supports a UE capability of prioritizing the scheduling operation,
the control section performs control to prioritize the scheduling operation in the target resource upon receipt of the scheduling instruction from the base station.

3. The terminal according to claim 1, wherein:
when an instruction of prioritizing the scheduling operation is received from the base station,
the control section performs control to prioritize the scheduling operation in the target resource upon receipt of the scheduling instruction from the base station.

4. The terminal according to claim 1, wherein:
when the terminal supports a UE capability of prioritizing the scheduling operation, and when an instruction of prioritizing the scheduling operation is received from the base station,
the control section performs control to prioritize the scheduling operation in the target resource upon receipt of the scheduling instruction from the base station.

5. A communication method, comprising:
when a scheduling instruction is received from a base station, controlling which of an RRM measurement operation and a scheduling operation is to be executed with priority in a target resource of a SMTC window or a measurement gap, according to whether or not a criterion of prioritizing the scheduling operation is satisfied;
when the scheduling operation is to be prioritized, performing downlink reception or uplink transmission in the target resource; and
when the RRM measurement operation is to be prioritized, measuring reception quality in the target resource.
